(19) United States
(12) Patent Application Publication
(10) Pub. No.: US 2004/0089511 A1
(43) Pub. Date: May 13, 2004

(54) Clutch assembly

(75) Inventor: Ron Bergman, McIntosh, MN (US)

Correspondence Address: MERCHANT & GOULD PC, P.O. BOX 2903, MINNEAPOLIS, MN, 55402-0903, US

(73) Assignee: Arctic Cat, Inc., Thief River Falls, MN

(21) Appl. No.: 10/290,845

(22) Filed: Nov. 7, 2002

(51) Int. Cl. F16H 9/12

(52) U.S. Cl. 192/54.5; 192/93 A; 474/19

(57) ABSTRACT

A clutch assembly for a personal recreational vehicle is disclosed. The clutch assembly includes a stationary shave including a central shaft-receiving portion for receiving a shaft. The shaft-receiving portion includes first and second ends. Each of the first and second ends includes a seal receiving section. Sealing members are received into a respective seal receiving section. A volume is created between the shaft and the have receiving portion when the seals are received into their respective seal receiving section. Optionally, a lubricant can be confined within the sealed volume.

### FIELD OF THE INVENTION

The invention relates generally to clutches, and more particularly to an improved clutch sealing assembly for use with clutches that are used in personal recreational vehicles.

### BACKGROUND OF THE INVENTION

Personal recreational vehicles, such as snowmobiles and ATVs, are used by millions of people for sport and fun. To illustrate, snowmobiling is a sport enjoyed by individuals of all ages and walks of life. Although interest in snowmobiling has traditionally been considerable, in recent years the sport has seen its popularity soar. For example, according to the International Snowmobile Manufacturers Association, about 82,000 snowmobiles were sold in the United States in 1992. By 1997, that number topped 170,000 units.

Similarly, the number of Americans driving off-road vehicles such as ATVs increased from 19.4 million in 1983 to 27.9 million in 1995. The increase in use of personal recreational vehicles is partly due to technological advancements of the equipment, advances that have made use safer and easier for persons of differing levels of ability.

For example, snowmobiles have become more comfortable, responsive and maneuverable, resulting in a more pleasing and exciting riding experience for the driver. One advancement of particular importance is the improvement in the maneuverability and stability of snowmobiles. As these characteristics have advanced, a greater number of individuals have been drawn to the sport. The industry has kept pace with the growth in the sport by expanding the number of models available across a range of prices. ATVs have seen similar types of improvements.

Personal recreation vehicles are typically operated and used in harsh environments. For example, ATVs are often operated in mud or water. Similarly, snowmobiles are often operated in slush, salt or even muddy areas. Additionally, the under-hood area also has much debris, for example, belt generated dust.

As a result of operating in such a harsh environment, the components are often subjected to the elements, for example, mud, water, dirt, and slush. As such, many of the components need cleaning or maintenance to remove the matter or clean the parts. One area that is affected by the above-mentioned items is the clutch and its components.

For the reasons stated, it is desirable to devise a means by which the clutch assembly can be protected from or made more resistant the elements.

### SUMMARY OF THE INVENTION

Against this backdrop, the invention has been created. One aspect of the present invention is directed to a clutch assembly. The clutch assembly includes a stationary sheave having a center shaft-receiving section. The shaft-receiving section includes a first end and a second end. Each of the first and second ends includes a seal receiving section for housing a sealing member. In one example embodiment, the sealing member is held between an inner shoulder and an outer lip in the sealing section.

Another aspect of the present invention is directed to a personal recreational vehicle having an engine coupled to a clutch driven assembly. The clutch assembly includes a stationary sheave having a center shaft-receiving section. The shaft-receiving section includes a first end and a second end. Each of the first and second ends includes a seal receiving section for housing a sealing member. In one example embodiment, the sealing member is held between an inner shoulder and an outer lip in the sealing section.

Another aspect of the present invention is directed to a method of assembling a clutch assembly. Mounting posts on a moveable sheave are inserted through their respective openings in a stationary sheave. A torque bracket is then coupled to a side of the stationary sheave opposite a side facing the moveable sheave. A driven spring is placed between the moveable sheave and a retainer plate. Ends of the mounting posts are received into their respective openings in the retainer plate and the ends each receive a fastener, thereby securing the retainer plate in place. A shaft is received through a shaft-receiving section of the moveable sheave. A lubricant is placed in a volume created between the outer surface of the shaft and the inner surface of the shaft-receiving section. Sealing members are placed at each end of the shaft-receiving section into a respective recessed portion, wherein each seal is held in place between an inner shoulder and an outer lip.

These and various other features as well as advantages which characterize the present invention will be apparent from a reading of the following detailed description and a review of the associated drawings.

### BRIEF DESCRIPTION OF THE DRAWINGS

The invention may be more completely understood in consideration of the following detailed description of various embodiments of the invention in connection with the accompanying drawings, in which:

FIG. 1 is a side view of a snowmobile of a type that can incorporate an example embodiment of the unitary housing of the present invention.

FIG. 2 is an elevation view of an example embodiment of a clutch assembly of the type that can be used with the present invention.

FIG. 3 is a perspective view of another example embodiment of a clutch assembly of the present invention.

FIG. 4 is an exploded view of the clutch assembly shown in FIG. 3.

FIG. 5 is a front view of a stationary sheave of the clutch assembly of FIG. 4.

FIG. 5A is a section view of the stationary sheave of FIG. 5 taken along line A-A.

FIG. 6 is a front perspective view of the stationary sheave of FIG. 5.

FIG. 7 is a sectional view of a shaft-receiving section.

FIG. 8 is an exploded perspective view a drive train including an example embodiment of a driven clutch assembly according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

In the following description of preferred embodiments of the present disclosure, reference is made to the accompanying drawings that form a part hereof, and in which is shown by way of illustration specific embodiments in which the disclosure might be practiced. It is understood that other embodiments may be utilized and structural changes may be made without departing from the scope of the present invention.

In general, the present disclosure discusses a clutch assembly for use in a personal recreational vehicle system. The clutch assembly reduces fretting, rattling and allows lubricant to be sealed in the clutch assembly, and has other desirable properties.

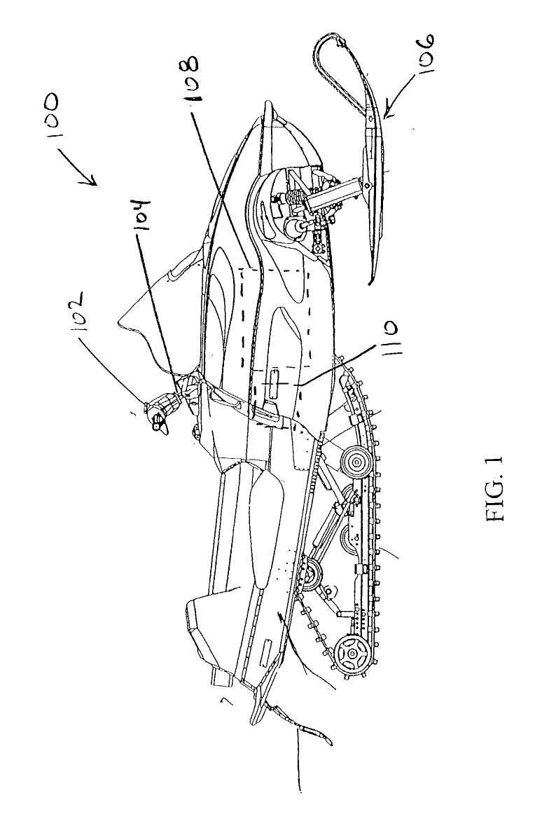

FIG. 1 depicts a personal recreational vehicle, a snowmobile 100, with a steering mechanism 102 that controls the orientation of a set of front wheels 106 via a steering shaft 104. The steering shaft 104 couples the steering mechanism 102 with the front wheels 106 via tie rods (not shown) that connect the steering shaft 104 to the suspension system (not shown) of the front wheels 106. The details regarding the coupling of the steering shaft 104 and the suspension system for the wheels 106 vary from snowmobile to snowmobile and are known and are not the focus of the present invention. Therefore, they are not discussed further.

As the steering mechanism 102 is turned, the front wheels 106 also turn, thereby controlling the direction in which the snowmobile 100 moves. An engine 108 is mounted toward the front of the chassis of the snowmobile 100. The engine provides power to the drive train (not shown) of the snowmobile 100. The details of the drive train vary from snowmobile to snowmobile, but according to the present invention, the snowmobile will have a clutch assembly 110 to allow for changing of the gearing during operation. The clutch assembly will typically be located on a portion of the drive train of the snowmobile near the engine. However, the location can vary depending on the snowmobile. Similarly, the clutch assembly of the present disclosure can be used on an ATV, and its use and placement are dictated by considerations similar to those in using the power distribution in a snowmobile.

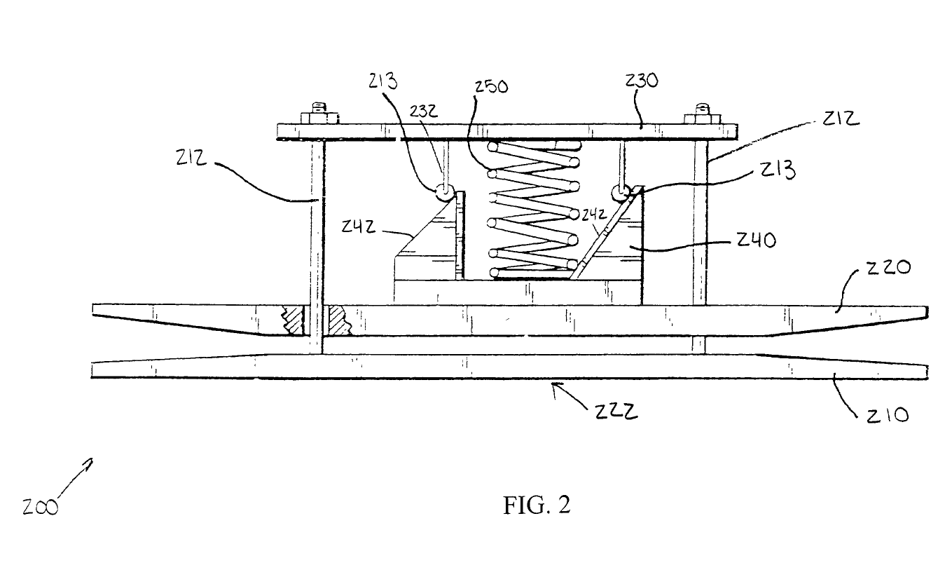

Referring to FIG. 2, an example embodiment of a clutch assembly 200 that can be used with the invention of the present disclosure is shown. Roller retainer plate 230 is biased apart from stationary sheave 220 with driven spring 250. Mounting posts 212 extend through oversized slots in stationary sheave 220. Roller bearings 213 connected to roller retainer plate 230 roll along a hypotenuse of curved triangularly-shaped ramps of torque bracket 240.

A force, provided by conventional centrifugal weights during normal vehicle operation is applied to roller retainer plate 230 in a direction perpendicular to the plane of plate 230. This force is transmitted down through roller 232 to the ramps 242 of torque bracket 240. Because of the inclined ramp, this force is resolved into two force components. A y-component force acts to compress spring 250 and an x-component force acts to turn plate 230 and moveable sheave 210, which are bolted together, so that rollers 232 move down the ramp causing plate 230 and stationary sheave 220 to move closer together.

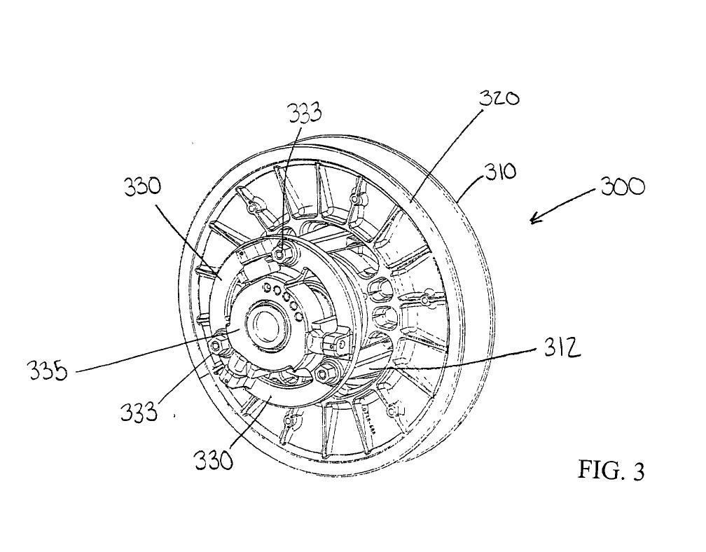

The angle of the ramp with respect to the stationary sheave 220 determines just how much of the applied force is used to compress spring 250. The greater the angle of the ramp, the greater the portion of the applied force that may be used to compress spring 250. The torque bracket 240 typically utilizes fixed angle ramps, and the portion of the applied force that may be used to compress spring 250 remains constant. The stationary sheave 220 shown includes a central shaft-receiving portion 222, which includes seal retaining sections, which will be described in detail with respect to the embodiment described in FIGS. 3-6.

Referring to FIGS. 3-6, another example embodiment of a clutch assembly 300 according to the present disclosure is shown. The clutch assembly 300 includes a moveable sheave 310 and a stationary sheave 320. The moveable sheave 310 includes one or more mounting posts 312 that extend towards and through post through openings in the stationary sheave 320. The clutch assembly 300 also includes a torque bracket 340 that is coupled to the stationary sheave 320 on the side opposite the moveable sheave 310.

The torque bracket 340 cooperatively engages a driven spring 350. The driven spring 350 is typically a helical spring that also includes a first end finger 351 and a second end finger 352. The first end finger 351 is coupled to a receiving portion 353 (not shown) on the stationary sheave 320. The second end finger 352 is coupled to a receiving portion 354 (not shown) of a retainer plate 330. The retainer plate 330 includes one or more openings 331 for receiving a respective mounting post 312. When the clutch assembly 300 is assembled, the retainer plate 330 is located so that each opening 331 is aligned with and receives its respecting mounting post 312. Securing fasteners 333, for example, lock nuts, at a threaded end of each respective mounting post 312, then fastens the retainer plate 330. Referring to FIG. 3, an assembled clutch assembly 300 according to the present disclosure is shown.

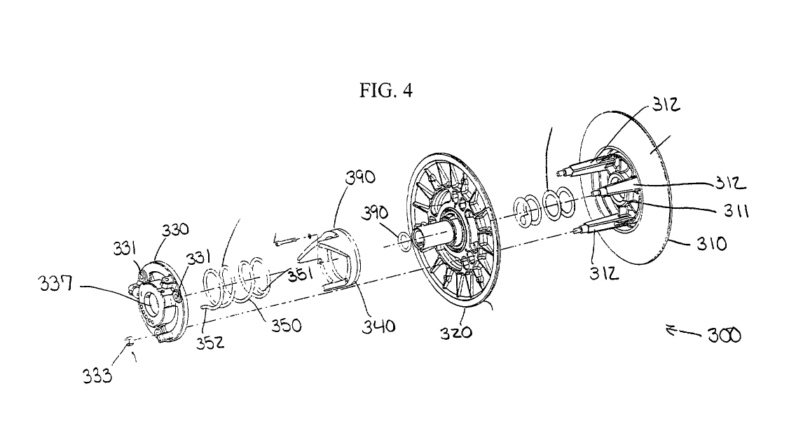

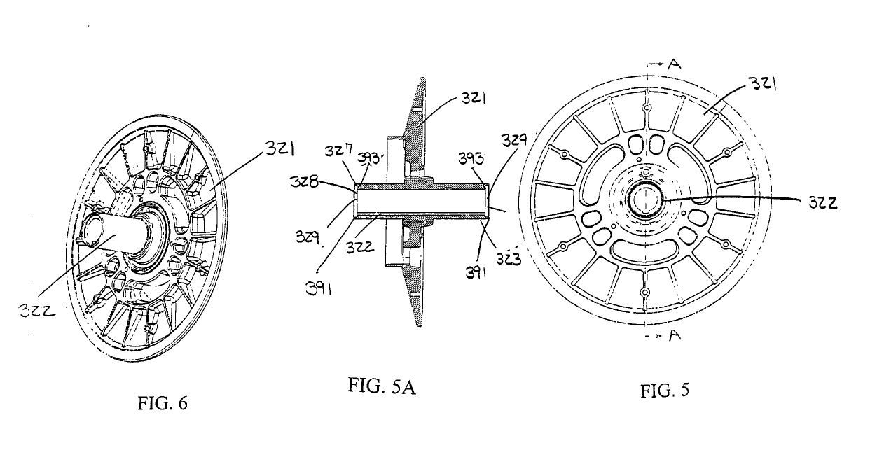

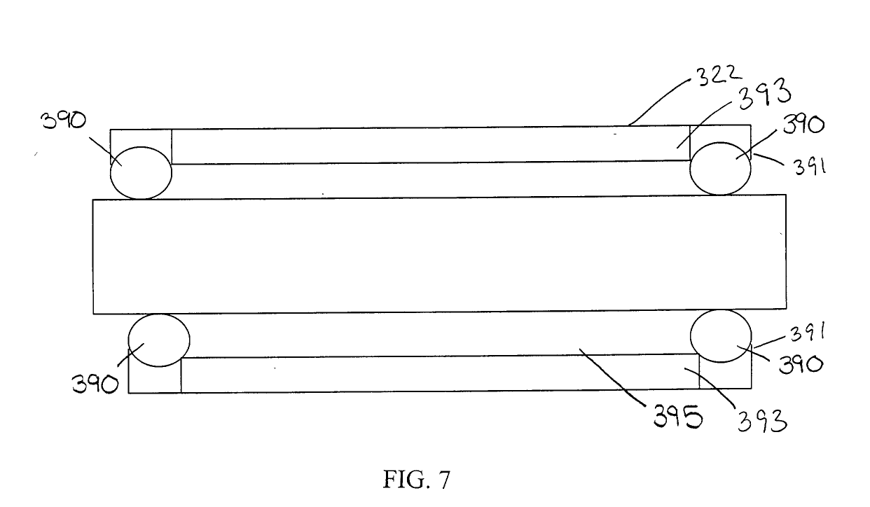

Referring to FIGS. 5-6, an example embodiment of a stationary sheave 320 is shown. The stationary sheave 320 includes a main plate section 321 surrounding a central shaft-receiving portion 322. The shaft-receiving portion 322 includes a first end 323 and a second end 327. The first end 323 is received into and passes through a center opening 311 in the moveable sheave 310 (as seen in FIG. 4) when the clutch assembly 300 is assembled. The second end 327 is received into and passes through a center opening 337 of the retainer plate 330 (as seen in FIG. 4). The second end 327 of the shaft-receiving portion 322 is roughly flush with the outer surface 335 of the retainer plate 230. The shaft-receiving portion 322 of the stationary sheave 320 is sized to receive and house a clutch shaft (not shown). The selection and sizing of the clutch shaft is known to one skilled in the art and does not form a part of the present invention.

The first and second ends 323, 327 of the shaft-receiving portion 322 of the stationary sheave 320 each include a seal retaining section 329. Each seal retaining section 329, as shown in FIG. 5A, includes a recessed portion 328. The recessed portion 328 receives and retains a sealing member 390. Preferably, the sealing member 390 is an O-ring, but other sealing members 390, for example, polymeric washers, lipseals, square seals or other such seals can be used. So that the sealing member 390 is retained in the retaining section 329, preferably each recessed portion 328 also includes an outer lip 391 to prevent the sealing member 390 from moving laterally outward in the retaining section 329. Each recessed section 328 also preferably includes an inner shoulder 393 to prevent the sealing member 390 from moving laterally inward in the retaining section 329.

When the clutch assembly 300 is coupled onto the shaft (not shown) passing through the shaft-receiving portion 322 of the stationary sheave 320, there is typically a small amount of clearance between the outer diameter of the shaft and the inner diameter of the shaft-receiving portion 322, thereby forming a sealed volume 395. One advantage of the invention of the present disclosure is that a lubricant, for example, oil or grease, such as axle or Neverseize® grease, may be confined in the volume 395. The sealing members 390 keep the lubricant from leaking out of the volume 395. Also, the sealing members 390 keep undesirable substances, such as dirt, debris or water, from getting into the sealed volume 395. The sealing members 390 also reduce and cushion the rattling of the shaft within the clutch assembly 300 induced by transverse movement of the shaft relative to the clutch assembly 300.

An additional advantage of the invention of the present disclosure is that, as a result of the combination retention of the lubricant and reduction in rattling, fretting between the inner shaft of the clutch and the cross-shaft (not shown) is reduced or eliminated. Fretting, which occurs when two normally tight fitting components begin to loosen, they collide against one another. The constant collisions cause localized spalling or flaking, and the surfaces begin to pit. This increases the local fatigue and can also cause oxidation of the pitted surface. By preventing debris from entering the volume between the shaft and the shaft-receiving portion, coupled with confining the lubricant, the clutch floats slightly over the shaft, and there is a resulting increase in performance a decrease in the amount of maintenance required.

A method for assembling a clutch assembly 300 of the present invention is also disclosed. The mounting posts 312 on the moveable sheave 310 are inserted through their respective openings in the stationary sheave 320. The torque bracket 340 is then coupled to the side of the stationary sheave 320 opposite the side facing the moveable sheave. The driven spring 350 is placed between the moveable sheave 310 and the retainer plate. The ends of the mounting posts 312 are then received into their respective openings in the retainer plate and the ends each receive a fastener, thereby securing the retainer plate in place. Next, a shaft is received through the shaft-receiving section of the moveable sheave. A lubricant is placed in the volume created between the outer surface of the shaft and the inner surface of the shaft-receiving section. Sealing members are then placed at each end of the shaft-receiving section into a respective recessed portion, wherein it is held in place between an inner shoulder and an outer lip.

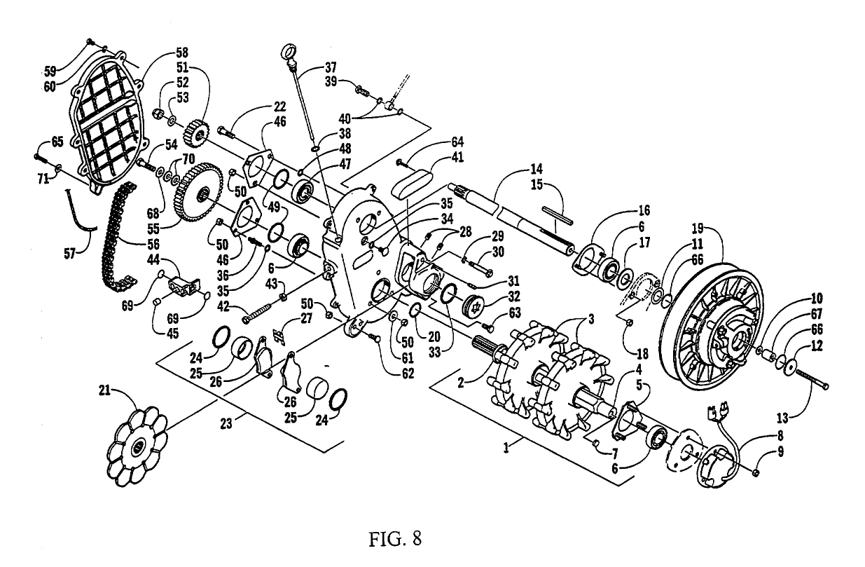

Referring to FIG. 8, a drive train assembly 100 for a personal recreational vehicle is shown. The drive train 100 includes a driven clutch 19. The driven clutch 19 is driven by a driving clutch (not shown), which is located between the engine (not shown) and the driven clutch 19 and transmits power therebetween. The driven clutch 19 includes a clutch shaft 14 that passes through a clutch shaft opening 102 in the drop case 23. The clutch shaft 14 is received into and passes through a bearing 47 in the clutch shaft opening 101 in the drop case 23. The clutch shaft 14 has a first gear 51 mounted on the end of the clutch shaft 14 housed in the drop case 23. The first gear 51 drives a driving chain or belt 56, which is also in communication with a second gear 55 housed in the drop case 23. The second gear 55 is directly coupled to a first end of the track shaft 4. The track shaft 4 drives the tracks of the vehicle, which in turn propels the vehicle.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A clutch assembly for a personal recreational vehicle comprising:
a stationary sheave having a center shaft-receiving section, the shaft-receiving section including a first end and a second end;
a seal receiving section at each said first and second end.

2. The clutch assembly of claim 1, further including a shaft passing through said shaft-receiving section.

3. The clutch assembly of claim 1, further including a first sealing member housed within the seal receiving section at said first end and a second sealing member housed within the seal receiving section at said second end.

4. The clutch assembly of claim 3, wherein each of said first and second sealing members is an O-ring.

5. The clutch assembly of claim 3, wherein a sealed volume is located within the shaft-receiving section and between first and second seal members.

6. The clutch assembly of claim 5, further including a lubricant within the sealed volume.

7. The clutch assembly of claim 6, wherein the lubricant is grease.

8. The clutch assembly of claim 6, wherein the lubricant is oil.

9. The clutch assembly of claim 1, wherein each seal receiving section includes an outer lip and an inner shoulder for hold a sealing member in place.

10. The clutch assembly of claim 1, further including an O-ring received into and housed within each seal-receiving section.

11. A personal recreational vehicle comprising:
an engine:
a driven clutch assembly coupled to the engine, the driven clutch assembly including:
a stationary sheave having a center shaft-receiving section, the shaft-receiving section including a first end and a second end;
a seal receiving section at each said first and second end.

12. The personal recreational vehicle of claim 11, wherein the vehicle further includes a shaft passing through said shaft-receiving section.

13. The personal recreational vehicle of claim 11, further including a first sealing member housed within the seal receiving section at said first end and a second sealing member housed within the seal receiving section at said second end.

14. The personal recreational vehicle of claim 13, wherein each of said first and second sealing members is an O-ring.

15. The personal recreational vehicle of claim 13, wherein a sealed volume is located within the shaft-receiving section and between first and second seal members.

16. The personal recreational vehicle of claim 15, further including a lubricant within the sealed volume.

17. The personal recreational vehicle of claim 16, wherein the lubricant is oil.

18. The personal recreational vehicle of claim 16, wherein the lubricant is grease.

19. The personal recreational vehicle of claim 11, wherein each seal receiving section includes an outer lip and an inner shoulder for hold a sealing member in place.

20. The personal recreational vehicle of claim 11, further including an O-ring received into and housed within each seal-receiving section.
